(19) United States
(12) Patent Application Publication
(10) Pub. No.: US 2005/0202267 A1
(43) Pub. Date: Sep. 15, 2005

(54) Plastic photochromic lens and method for preparation thereof

(75) Inventors: Jin-Wook Ha, Chungcheongnam-do (KR); Jin-Heon Ha, Seoul (KR); Jee-Nyu Hong, Gyeonggi-do (KR); Seung-Hyun Cho, Gyeonggi-do (KR)

Correspondence Address: NORRIS, MCLAUGHLIN & MARCUS, P.A., 875 THIRD AVE, 18TH FLOOR, NEW YORK, NY, 10022, US

(73) Assignee: Yujin Tech21 Co., Ltd., Chungcheongnam-do (KR)

(21) Appl. No.: 10/522,852

(22) PCT Filed: Nov. 29, 2002
(86) PCT No.: PCT/KR02/02251

§ 371 Date: Jan. 28, 2005

(51) Int. Cl. B32B 27/30

(52) U.S. Cl. 428/522

(57) ABSTRACT

Disclosed is a coating composition for a plastic photochromic lens and the plastic photochromic lens coated with the same. The coating composition includes a spiropyran photovariable color compound and/or spirooxazine photovariable color compound dissolved in toluene, and an acryl based binder. The plastic photochromic lens coated with the coating composition has advantages of short variable time, and good adhesion of the coating composition to the plastic lens and UV prevention effect without an undesirable haze phenomenon.

### TECHNICAL FIELD

The present invention relates, in general, to a plastic photochromic lens and a method of producing the same and, in particular, to a plastic photochromic lens having a short variable time, and a method of producing the same. Hereby, the variable time is defined as a time required for a lens to return to its original color when removed from the influence of sunlight or ultraviolet light after being discolored by exposure to the sunlight or ultraviolet light.

### BACKGROUND ART

As well known to those skilled in the art, a photochromic lens has a light color approaching to colorlessness indoors, but attains a dark depth of color outdoors when exposed to ultraviolet light or visible light having short wavelength. The photochromic lens is also called a ‘Corning lens’, originating from Corning Co. of United States of America, which initially produced it. Because the photochromic lens includes fine crystals such as silver chloride (AgCl), silver bromide (AgBr), and silver iodide (AgI) dispersed in a glass or plastic lens, the depth of color is changed according to the irradiation amount of ultraviolet light. In other words, the photochromic lens is defined as a lens making a repetition of coloring when being irradiated by ultraviolet light, and which becomes transparent when being not exposed to ultraviolet light.

As described above, the photochromic lens blocks ultraviolet light of sunlight to reduce eye strain and protect eyes from injurious ultraviolet light (UV-B) known for inducing cataracts, and since it filters 70 to 80% of sunlight, it can be applied to various applications. For example, the photochromic lens may act as sunglasses in summer when a great quantity of sunlight is irradiated, or outdoors.

Recently, various photovariable color compounds are used to produce photochromic lenses. The term photovariable color compound denotes a compound, being reversibly changed in terms of its color, discolored when being irradiated by ultraviolet light such as sunlight or mercury lamp light, and returns to its original color when not affected by ultraviolet light or stored in a dark room. Various types of photovariable color compounds have been synthesized, but these compounds do not have structural similarity. Initial studies of photovariable color compounds mostly focused on 1,3,3-trimethyl-indolinobenzospiropyran derivatives expressed by the following Formula: 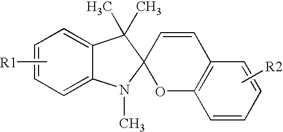
(wherein, R1 and R2 are various substituents)

To improve the above derivative, various photovariable color compounds have been suggested. Among them, a representative compound is a spirooxazine compound disclosed in U.S. Pat. Nos. 4,215,010 and 4,342,668. In addition to the spirooxazine compound, pyran derivatives such as spiropyran or naphtopyran, fulgide, acridone, and naphthacene quinone are known in the art.

Meanwhile, conventionally, photovariable color compounds were directly incorporated in monomers to be used to produce a lens for spectacles. However, this case is applied to only lenses made of glass, and the variable time of the lens is too long to sufficiently satisfy consumers. Additionally, there was also attempts of applying the photovariable color compound to lenses made of plastic; but this case was disadvantageous in that it was cumbersome to perform a process of applying the photovariable color compound to plastic lenses because microwaves were used or the photovariable color compound were coated on the plastic lens under vacuum condition.

### DISCLOSURE OF THE INVENTION

Therefore, it is an object of the present invention to provide a novel plastic photochromic lens, which can be easily produced and has short variable time.

The present inventors developed a plastic photochromic lens with short variable time and good surface strength and ultraviolet ray filtering effect without an undesirable haze phenomenon by dissolving spiropyran based compounds, spirooxazin based compounds, or a mixture thereof in toluene in a predetermined mixing ratio, then incorporating an acryl based binder to produce the resulting solution, coating the resulting solution on a plastic lens, and heat-curing the coated lens.

According to an aspect of the present invention, a coating composition for a plastic photochromic lens comprising 1.5 to 5 wt % spiropyran compound defined by the following Formula I, or spirooxazine compound defined by the following Formula II, or a mixture thereof, 60 to 65 wt % toluene, and an acryl based binder to make 100 wt % of the coating composition is provided: 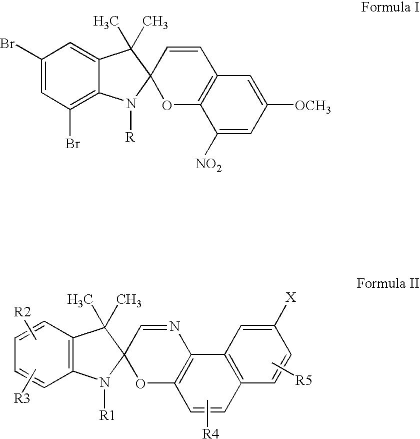
wherein,
R is alkyl with 1 to 30, carbon atoms,
R1 is alkyl, alkenyl, or alkoxy with 1 to 10 carbon atoms, or substituted or non-substituted phenyl,
R2 to R5 are independently hydrogen atom, halogen, cyano, nitro, or alkyl or alkoxy with 1 to 6 carbon atoms, and
X is hydroxy, glycidoxy, amine, or dichlorotrioxazinoxy.

According to another aspect of the present invention, provided is a plastic photochromic lens coated with a coating composition comprising 1.5 to 5 wt % spiropyran compound defined by the Formula I, or spirooxazine compound defined by the Formula II, or a mixture thereof, 60 to 65 wt % toluene, and an acryl based binder to make 100 wt % of the coating composition.

According to still another aspect of the present invention, provided is a method of producing a plastic photochromic lens comprising coating a surface of the plastic photochromic lens with a coating composition including 1.5 to 5 wt % spiropyran compound defined by the Formula I, or spirooxazine compound defined by the Formula II, or a mixture thereof, 60 to 65 wt % toluene, and an acryl based binder to make 100 wt % of the coating composition; and heat-curing the resulting structure.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a graph showing an UV/Vis spectrum for a plastic photochromic lens of the present invention, in which transmittance variation is plotted according to wavelength of light irradiated into the plastic photochromic lens.

### BEST MODE FOR CARRYING OUT THE INVENTION

According to the present invention, a spiropyran compound of Formula I, a spirooxazin compound of Formula II, or a mixture thereof is used as a photovariable color compound. The photovariable color compound is well known in the art, and for example, the spiropyran compound of Formula I is disclosed in U.S. Pat. No. 5,241,075, and the spirooxazin compound of Formula II is used as a starting material in Korean Pat. No. 1994-0023831 and can be derived from the spirooxazin compound disclosed in U.S. Pat. No. 4,342,668.

According to the present invention, the spiropyran compound of Formula I and the spirooxazin compound of Formula II may be used as the photovariable color compound alone or in a mixed form. It may be properly selected according to the desired color whether to use the above compounds alone or in a mixed form, depending on the type of the photovariable color compound. The spiropyran based compound and spirooxazin based compound absorb ultraviolet light from the sunlight and emit as violet, yellow, green, brown, red, or blue in color, but becomes transparent when it is not exposed to UV.

Photovariable color compounds of the present invention can be mixed together while being dissolved in toluene to produce a solution having a different color from the original colors of the components. For example, if a yellow liquid is mixed with a blue liquid to produce a coating liquid composition, a surface of the plastic lens coated with the coating liquid composition will be green. Meanwhile, an acryl based binder is useful as a binder of the present invention, and the binder may be selected from the group consisting of an organic binder, an inorganic binder, or a mixture thereof. In the present invention, the binder can be obtained as a commercial binder, or produced according to a conventional binder producing method.

Generally known as a solvent for dissolving the photovariable color compound is an organic solvent such as hexane, xylene, toluene, methylene chloride, ethyl acetate, and butyl acetate. According to the present invention, the spiropyran compound of Formula I, or the spirooxazin compound of Formula II, or a mixture thereof is most soluble in toluene and methylene chloride. However, in the case of using methylene chloride as the solvent, an undesirable haze phenomenon occurs on the plastic lens coated with the coating composition. Accordingly, toluene is most preferably used as the solvent in the present invention.

When the photovariable color compound of Formula I or II is dissolved in toluene, color of the resulting solution was varied according to the solubility. The results are described in Table 1.

TABLE 1

| Color | Solubility (%) |
|---|---|
| Violet | 3.0 |
| Blue | 5.0 |
| Yellow | 5.0 |
| Red | 5.0 |

According to the present invention, the coating composition for the plastic photochromic lens comprises 1.5 to 5 wt % spiropyran compound defined by Formula I, or spirooxazine compound defined by Formula II, or a mixture thereof, 60 to 65 wt % toluene, and an acryl based binder to make 100 wt % of the coating composition. For example, when an acryl based binder content is undesirably low, a coated layer is not completely attached to a surface of the plastic lens, thereby reducing adhesion and hardness. On the other hand, when the binder content is excessively high, viscosity is increased and the coated layer becomes thick, thereby making the surface of the coated layer uneven. Additionally, when the toluene content is undesirably high, depth of the color of the coated layer is lowered unless the photovariable color compound is additionally added. In other words, when toluene is added to the photovariable color compound in such an amount that the concentration of the photovariable color compound in toluene is less than the maximum soluble amount, depth of the color of the coated layer is lowered. On the other hand, when toluene is mixed with the photovariable color compound in such an amount that the concentration of the photovariable color compound in toluene is more than the maximum soluble amount, the photovariable color compound is not completely dissolved in toluene and will be precipitated on the bottom.

According to the present invention, the composition including the photovariable color compound of Formula I and/or Formula II, toluene, and the acryl based binder may be coated on the plastic lens by various coating processes such as a manually coating process, a spin coating process, a dip coating process, or a spray coating process.

As described above, the plastic lens is coated with the coating composition of the present invention, and heat-cured to produce a plastic photochromic lens. However, the photovariable color compound of the present invention has poor heat resistance. Therefore, if the curing temperature is too high, the plastic lens is not able to fulfill its function of changing color. On the other hand, when the curing temperature is too low, it takes a long time to cure the coating composition and occasionally curing is not completely conducted, thus reducing strength of the coated layer. Accordingly, it is preferable that the curing temperature is 30 to 80° C.

A better understanding of the present invention may be obtained in light of the following examples which are set forth to illustrate, but are not to be construed to limit the present invention.

### EXAMPLE 1

3 wt % photovariable color compound (manufactured by Unitech Co., Korea) defined by the following Formula was dissolved in 64 wt % toluene.

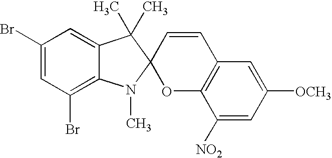

33 wt % acryl based organic•inorganic complex binder (A9540 manufactured by Aekyung Chemical Co., Korea) was added to this solution to produce a coating composition.

### EXAMPLE 2

5 wt % mixture of photovariable color compound (manufactured by Unitech Co., Korea) defined by the following Formulae was dissolved in 65 wt % toluene.

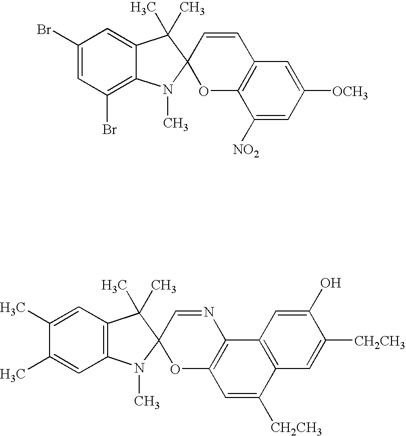

30 wt % acryl based organic inorganic complex binder (A9540 manufactured by Aekyung Chemical Co., Korea) was added to this solution to produce a coating composition for a plastic photochromic lens.

### EXAMPLE 3

The coating composition obtained from Example 1 was spin-coated on a surface of a plastic lens, and heat-cured at 80° C. to produce the plastic photochromic lens.

### EXAMPLE 4

The coating composition obtained from Example 2 was dip-coated on a surface of a RGP plastic lens, and heat-cured at 80° C. to produce the plastic photochromic lens.

### Experimental Test 1

Test of Variable Time

The plastic photochromic lens obtained from Example 3 was exposed to sunlight. Then, the exposed plastic photochromic lens turned brown. The brown plastic photochromic lens lost its color and became transparent within 1 min after the lens was moved to indoors where exposure to sunlight was blocked.

### Experimental Test 2

Mesurement of Ultraviolet Light Blocking Ratio

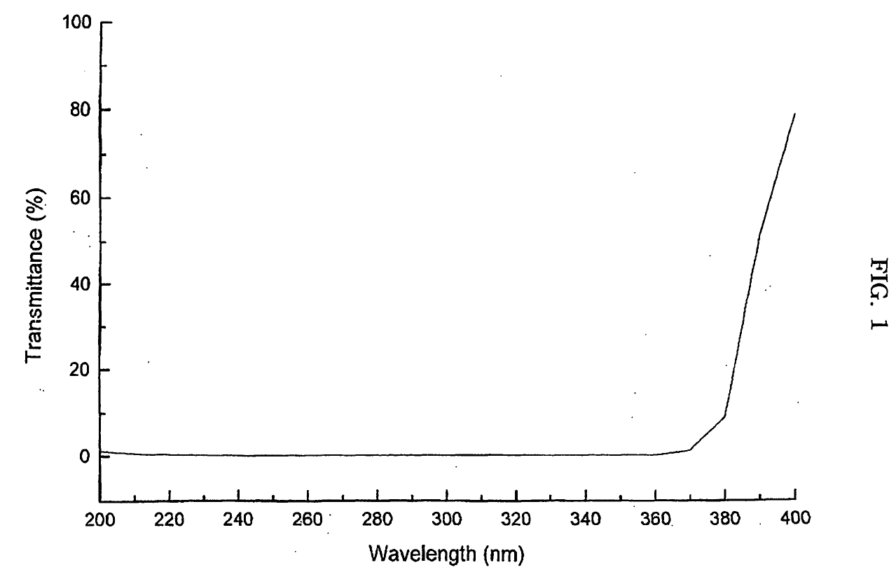

The plastic photochromic lens obtained from example 3 was measured in terms of transmissivity of ultraviolet light using a UV/Vis spectrum. The results are described in FIG. 1.

From the results of FIG. 1, it can be seen that the plastic photochromic lens of the present invention has a 99% or higher ultraviolet ray blocking ratio.

### Experimental Test 3

Mesurement of Adhesive Strength

The plastic photochromic lens obtained from example 3 was measured in terms of adhesive strength according to the KS D 6711-92 test procedure. The results were 100/100. This proves that the plastic photochromic lens according to the present invention has excellent adhesive strength.

### INDUSTRIAL APPLICABILITY

As described above, a plastic photochromic lens according to the present invention is advantageous in that its variable time is short, an undesirable haze phenomenon does not occur, and it has good adhesion of a coating composition to a plastic lens and ultraviolet ray filtering effect.

The present invention has been described in an illustrative manner, and it is to be understood that the terminology used is intended to be in the nature of description rather than of limitation. Many modifications and variations of the present invention are possible in light of the above teachings. Therefore, it is to be understood that within the scope of the appended claims, the invention may be used otherwise than as specifically described.

1. A coating composition for a plastic photochromic lens, comprising 1.5 to 5 wt % spiropyran compound defined by Formula I and spirooxazine compound defined by Formula II; 60 to 65 wt % toluene; and an acryl based binder to make 100 wt % of the coating composition. 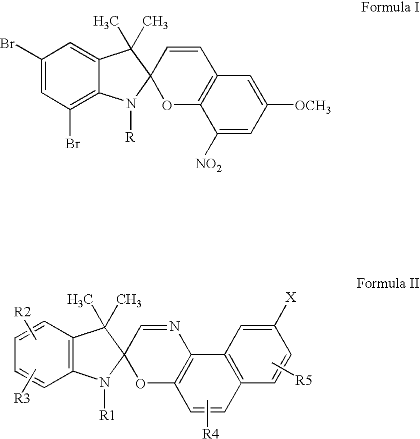
(wherein,
R is alkyl with 1 to 30 carbon atoms;
R1 is alkyl, alkenyl, or alkoxy with 1 to 10 carbon atoms, or substituted or non-substituted phenyl;
R2 to R5 are independently hydrogen atom, halogen, cyano, nitro, or alkyl or alkoxy with 1 to 6 carbon atoms; and
X is hydroxy, glycidoxy, amine, or dichlorotrioxazinoxy)

2. A plastic photochromic lens coated with the coating composition according to claim 1.

3. A method of producing a plastic photochromic lens, comprising:
coating a surface of a plastic lens with the coating composition according to claim 1; and
heat-curing the resulting structure.

4. The method according to claim 3, wherein the heat-curing is performed at the temperature of 30 to 80° C.
